(19) United States
(12) Patent Application Publication
(10) Pub. No.: US 2008/0066288 A1
(43) Pub. Date: Mar. 20, 2008

(54) METHOD FOR APPLYING A HIGH TEMPERATURE ANTI-FRETTING WEAR COATING

(75) Inventors: D. Keith Patrick, Cincinnati, OH (US); Jerry D. Schell, Evendale, OH (US); Michael J. Weimer, Loveland, OH (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/530,157

(22) Filed: Sep. 8, 2006

(51) Int. Cl. B23P 25/00; B23P 15/02

(52) U.S. Cl. 29/458; 29/889.7; 29/527.2

(57) ABSTRACT

A method for applying a high temperature anti-fretting wear coating is disclosed. The method includes providing a gas turbine engine blade as a substrate in which the gas turbine engine blade has a mating surface for contacting a corresponding gas turbine engine component and applying a high temperature bond coat overlying the substrate using air plasma spraying, resulting in an inspectable, repairable turbine blade.

### FIELD OF THE INVENTION

This invention relates to methods of applying anti-fretting wear coatings to metal surfaces, and more particularly, to applying such coatings using air plasma spraying.

### BACKGROUND OF THE INVENTION

Very small movements or vibrations at the juncture between mating components in gas turbine engines have resulted in what is commonly called fretting or fretting wear. Typical component combinations include fan or compressor blades carried by a rotor or rotating disc. Such occurrence of wear can require premature repair or replacement of one or both components or their mating surfaces if not avoided. In modern gas turbine engine compressors, it has been noted that Ti alloys have relatively poor anti-fretting wear or anti-friction characteristics. For example, such Ti alloys as commercially available and widely used Ti 6-2-4-2 alloy (nominally by weight about 6% Al, 2% Sn, 4% Zr, 2Mo, balance Ti) have relatively high room temperature yield strengths, such as greater than about 100 ksi, which can result in fretting wear with an abutting member such as blade slot during operation.

One commonly used anti-fretting coating combination is a Cu—Ni—In alloy (nominally by weight 36% Ni, 5% In, balance Cu) applied to a mating surface of a component and then covered by a molybdenum disulfide solid film lubricant. The Cu—Ni—In alloy and its application to a gas turbine engine component to avoid such wear is described in U.S. Pat. No. 3,143,383. Although such an alloy has been effective for certain lower temperature uses, its yield strength is insufficient for use at higher temperatures and stresses, for example in more advanced gas turbine engines which may operate in the range of about 343° C. (650° F.) to about 593° C. (1100° F.). Similarly, the use of molybdenum disulfide, which is mixed with an organic binder such as an epoxy, is inadequate as it oxidizes and loses effectiveness above about 343° C. (650° F.), causing extrusion of the coating combination and wear of the underlying base material.

More recently, application of high temperature wear resistant coatings to the dovetail pressure face of a gas turbine compressor or turbine blade has been by applying a powdered metal bond coat by a high-velocity oxygen fuel (HVOF) or “D-Gun” thermal spray process, such as disclosed by U.S. Pat. No. 5,518,683 to Taylor et al. Taylor describes a wear coating applied by the HVOF method for high temperature wear resistance followed by application of a dry film lubricant for lubricity when wear occurs against a mating surface.

However, HVOF coatings cannot be removed by conventional repair practices and thus the component substrate cannot be inspected for edge-of-contact cracking. As such, compressor or turbine blade components having the HVOF coatings are rendered non-repairable because the HVOF coating cannot be readily removed from the dovetail pressure face without possible damage to the underlying substrate or changes in the critical dimensions required for the particular application.

What is needed is a method of applying anti-fretting wear coatings suitable for use on compressor or turbine blade components that can be removed, permitting inspection and repair of the component, after which the coating can be reapplied prior to returning the components to service.

### SUMMARY OF THE INVENTION

The present invention addresses these and other needs by applying an anti-fretting wear coating to a mating surface of a gas turbine engine blade by using an air plasma spray (APS) process.

A method of applying an anti-fretting wear coating is disclosed. The method comprises providing a gas turbine engine blade as a substrate, the gas turbine engine blade having a mating surface for contacting a corresponding gas turbine engine component; and air plasma spraying a high temperature bond coat to at least a portion of the mating surface of the substrate. This results in an inspectable, repairable gas turbine engine in that the APS coating can subsequently be removed to permit inspection and repair of the blade at some time in the future.

A repairable gas turbine engine blade having an anti-fretting wear coating is also disclosed. The blade comprises a repairable titanium-aluminide gas turbine engine blade comprising an air foil portion and a dovetail portion, the dovetail portion having a pressure face and a non-pressure face, wherein an air-plasma sprayed high temperature bond coat overlies the dovetail pressure face.

One advantage of the invention is that applying an anti-fretting wear coating by an APS process to components of a gas turbine engine allows the components to subsequently be economically stripped, inspected, repaired (if needed), recoated and returned to service.

Another advantage of the invention is that the method provides an anti-fretting wear coating that may exhibit wear superior to that by applying the same coating using HVOF.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a gas turbine engine blade.

FIG. 2 illustrates a portion of a gas turbine engine blade having an anti-fretting wear coating applied in accordance with exemplary embodiments of the invention.

### DETAILED DESCRIPTION OF EXEMPLARY EMBODIMENTS

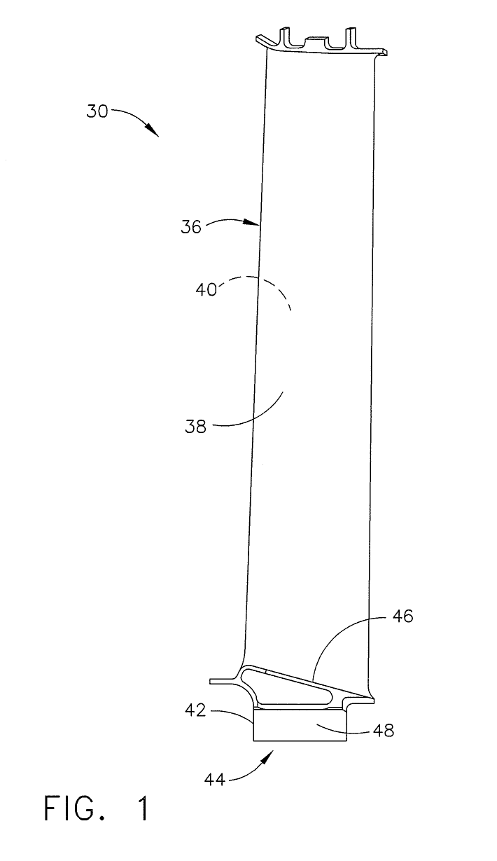

With reference to FIG. 1, a gas turbine engine blade 30 is illustrated. The gas turbine engine blade 30 has an airfoil 36 including a pressure side 38, against which a flow of gas impinges during service operation, and an oppositely disposed suction side 40. The gas turbine blade 30 further includes a downwardly extending shank 42, and an integral attachment in the form of a dovetail 44, which attaches the gas turbine blade 30 to a gas turbine disk (not shown) of the gas turbine engine. A platform 46 extends transversely outwardly at a location between the airfoil 36 and the shank 42 and dovetail 44.

The blade 30 may be any gas turbine engine blade including a compressor blade or a turbine blade, and more particularly may be either a low pressure turbine blade or a high pressure turbine blade. During operation, the dovetail 44, and particularly the pressure side 48 of the dovetail 44 is subjected to contact with the gas turbine disk by vibration and rubbing resulting in wear to the dovetail 44. This wear may be increased when the blade 30 and disk are of different base alloy compositions, such as a titanium-base alloy blade and a nickel-base alloy disk.

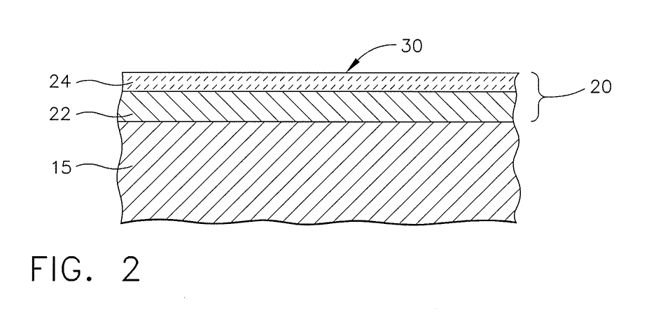

Referring now to FIG. 2, a portion of the blade 30 serves as a substrate 15 to which the anti-fretting wear coating is applied in accordance with exemplary embodiments of the invention. Typically, the wear coating is applied to the dovetail 44, and more typically to the pressure face 48 of the dovetail 44, which has at least one surface that mates with a corresponding surface of the gas turbine disk, and both of which are subjected to a significant amount of rubbing during engine operation.

The substrate 15 may be constructed of any operable material. Examples include nickel-base alloys such as nickel-base superalloys strengthened by the precipitation of gamma-prime or a related phase, iron-base alloys, cobalt-base alloys, and titanium-base alloys.

A substrate 15 of particular current interest is titanium aluminide (TiAl), including gamma titanium aluminides and alpha-2 titanium aluminides. One particularly suitable titanium aluminide for use as the substrate 15 has a composition of about 32 to about 33.5 weight percent (wt %) aluminum, about 4.5 to about 5.1 wt % niobium, about 2.4 to about 2.7 wt % chromium, about 0.04 to 0.12 wt % oxygen, up to about 0.020 wt % nitrogen, up to about 0.015 wt % carbon, up to about 0.10 wt % iron, up to about 0.001 wt % hydrogen, up to about 0.050 wt % impurities, and the balance titanium.

Prior to coating, the surface of the substrate 15 may be prepared by dry or wet blasting to a surface roughness of about 80 to about 150 microinches Ra, as well as masking any areas that do not need coated. An anti-fretting wear coating 20 is applied overlying the substrate 15. The anti-fretting wear coating 20 comprises a high temperature bond coat 22 and, optionally, a layer of dry-film lubricant 24. The high temperature bond coat 22 is applied by air plasma spraying techniques using either a powder or wire feed. By “high-temperature bond coat” is meant a bond coat comprising any material that has a composition stable above about 343° C. (650° F.), such as a nickel-chromium alloy. It has been discovered that methods according to exemplary embodiments of the present invention result in high temperature bond coats that may be stable from about 343° C. (650° F.) up to about 704° C. (1300° F.).

One suitable high temperature bond coat 22 is a nickel-chromium alloy having a composition of about 58 to about 62 weight percent (wt %) nickel, about 14 to about 18 wt % percent chromium, about 1.3 to about 1.7 wt % silicon, and a total of about 0.23 maximum wt % of impurities, which is commercially available as METCOLOY® 33 from Sulzer Metco of Winterthur, Switzerland. The high temperature bond coat is typically applied to a thickness of about 0.0254 mm (0.001 inches) to about 0.305 mm (0.012 inches).

Optionally, the anti-fretting wear coating also comprises a high temperature dry film lubricant 24 applied overlying the high temperature bond coat 20. The dry film lubricant 24 typically comprises graphite and may further comprise either one or both of silicates (for example, LOB1800 available from Everlube Products of Peachtree City, Ga.) or aluminum phosphates (for example, EVERLUBE® 853, also available from Everlube Products) and may be applied to a thickness of about 0.013 mm (0.0005 inches) to about 0.102 mm (0.004 inches). The application of the dry film lubricant 24 may be by spraying, brushing, dipping or any other suitable methods, but typically is applied by spraying followed by a heat treatment cycle to cure it.

The combination of the APS application of the high temperature bond coat 22 and dry film lubricant 24 results in an anti-fretting wear coating that reduces friction, and thus wear, between the coated gas turbine engine blade and the disk. Embodiments of the present invention may reduce the coefficient of friction (both sliding and break) between the mated components to less than about 0.6 and more preferably to less than about 0.4. Thus, the application of the high temperature bond coat 22 by air-plasma spraying protects the mating surfaces of the gas turbine engine blades to which it is applied, such as the dovetail pressure face 48 of a low pressure turbine blade, while in service.

The method of applying the high temperature bond coat 22 by APS has the further advantage of permitting the blades to be inspected and/or repaired at each service interval. At a service interval, each blade can be separated from its disk and the APS-applied high temperature bond coat removed by grit blasting, chemical stripping, or water jet stripping by way of example only. Once removed, the underlying substrate may be inspected for cracks or other possible sources of failure in need of repair. Such inspection and repair is not currently feasible when HVOF application techniques are used, since the HVOF coatings cannot readily be removed without possible damage to the underlying substrate.

Following inspection and any needed repairs, the anti-fretting wear coating can then be re-applied to the dovetails 44 so that the repaired blades 30 may be returned to service, thereby permitting continued use of turbine blades that otherwise may have been discarded.

Wear and friction results are shown with respect to the following example of the invention, which has been reduced to practice. These results demonstrated that methods of applying a high temperature bond coat by APS techniques resulted in wear and friction that were generally at least as good or better as those typically found in bond coats applied by HVOF techniques.

### EXAMPLE

Shoes of titanium aluminide were coated with a METCOLOY® 33 bond coat by APS to a thickness of about 0.064 mm (0.0025 inches) to about 0.114 mm (0.0045 inches). Several samples were coated with a layer of dry-film lubricant over the bond coat to a thickness of about 0.013 mm (0.0005 inches) to about 0.051 mm (0.002 inches). Both LOB1800 and EVERLUBE® 853 dry film lubricants were used in separate tests and the results combined and averaged. Sliding wear tests were conducted on the samples according to GE Aviation Specification E50TF76 with parameters modified to match the performance requirements for the specific application at temperatures of 427° C. (800° F.) and 538° C. (1000° F.) and applied pressures between 34.5×10³ kPa (5,000 psi) and 137.9×10³ kPa (20,000 psi). The results were compared with sliding tests on bare titanium alumnide, as well as coated and uncoated samples in which the bond coat was applied by HVOF. Averaged results are shown in Table 1 below.

TABLE 1

| | | Avg. Sliding | Final Sliding |
|---|---|---|---|
| | Avg. Wear | Friction | Friction |
| Shoe materials | (in.) | Coefficient | Coefficient |
| TiAl | −4.0 × 10⁻³ | 0.537 | 0.565 |
| TiAl + M33 | −1.3 × 10⁻⁴ | 0.547 | 0.563 |
| (HVOF) | | | |
| TiAl + M33 (APS) | −5.5 × 10⁻⁵ | 0.457 | 0.433 |
| TiAl + M33 + DFL | −1.6 × 10⁻³ | 0.410 | 0.425 |
| (HVOF) | | | |
| TiAl + M33 + DFL | −8.4 × 10⁻⁴ | 0.358 | 0.352 |
| (APS) | | | |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method comprising:
providing a gas turbine engine blade as a substrate, the gas turbine engine blade having a mating surface for contacting a corresponding gas turbine engine component; and
air plasma spraying a high temperature bond coat to at least a portion of the mating surface of the substrate.

2. The method of claim 1 wherein the gas turbine engine blade is a turbine blade.

3. The method of claim 1 wherein the gas turbine engine blade is a compressor blade.

4. The method of claim 1 wherein the gas turbine engine blade comprises a nickel-base alloy, an iron-base alloy, a cobalt-base alloy, a titanium-base alloy, or combinations thereof.

5. The method of claim 1 wherein the gas turbine engine blade comprises a titanium aluminide alloy.

6. The method of claim 5 wherein the titanium aluminide alloy has a composition of about 32 to about 33.5 weight percent (wt %) aluminum, about 4.5 to about 5.1 wt % niobium, about 2.4 to about 2.7 wt % chromium, about 0.04 to about 0.12 wt % oxygen, up to about 0.020 wt % nitrogen, up to about 0.015 wt % carbon, up to about 0.10 wt % iron, up to about 0.001 wt % hydrogen, up to about 0.050 wt % impurities, and the balance titanium.

7. The method of claim 5 wherein the titanium aluminide alloy is a gamma titanium aluminide.

8. The method of claim 1 wherein the step of air plasma spraying comprises air plasma spraying a nickel-chromium alloy bond coat overlying the substrate.

9. The method of claim 1 wherein the step of air plasma spraying comprises air plasma spraying an alloy having a composition of about 58 to about 62 weight percent (wt %) nickel, about 14 to about 18 wt % percent chromium, about 1.3 to about 1.7 wt % silicon, and up to about 0.23 wt % impurities.

10. The method of claim 1 further comprising applying a dry film lubricant overlying the high temperature bond coat.

11. The method of claim 10 wherein the dry film lubricant comprises graphite.

12. The method of claim 1 wherein the high temperature bond coat is stable at operational temperatures from about 650° F. to about 1300° F.

13. The method of claim 1 further comprising:
removing the high temperature bond coat to reveal at least a portion of the substrate;
inspecting the substrate; and thereafter re-applying a high temperature bond coat overlying the revealed portion of the substrate.

14. The method of claim 13 further comprising the step of repairing the substrate intermediate the steps of inspecting and re-applying.

15. A method comprising:
providing a titanium aluminide gas turbine engine blade as a substrate, the gas turbine engine blade having a mating surface for contacting a corresponding gas turbine engine component;
air plasma spraying a high temperature bond coat to at least a portion of the mating surface of the substrate; and
applying a dry-film lubricant overlying the high temperature bond coat.

16. The method of claim 15 comprising air plasma spraying the high temperature bond coat to a thickness of about 0.001 inches to about 0.012 inches.

17. The method of claim 15 comprising applying the dry-film lubricant to a thickness of about 0.0005 inches to about 0.004 inches.

18. The method of claim 15 comprising air plasma spraying a nickel chromium high temperature bond coat to at least a portion of the mating surface of the substrate.

19. A repairable gas turbine engine blade having an anti-fretting wear coating comprising:
a repairable titanium-aluminide gas turbine engine blade comprising an air foil portion and a dovetail portion, the dovetail portion having a pressure face and a non-pressure face, wherein an air-plasma sprayed high temperature bond coat overlies the dovetail pressure face.

20. The gas turbine engine of claim 19 wherein the titanium aluminide is a gamma titanium aluminide.
